(19) United States
(12) Patent Application Publication
(10) Pub. No.: US 2002/0026472 A1
(43) Pub. Date: Feb. 28, 2002

(54) Service request method and system using input sensitive specifications on wired and wireless networks

(76) Inventors: Gadi Wolfman, Bat Yam (IL); Ehud Rivlin, Haifa (IL); Yossef Matias, Tel Aviv (IL); Eytan Ruppin, Maccabim Reut (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/814,027

(22) Filed: Mar. 22, 2001

Related U.S. Application Data
(60) Provisional application No. 60/191,123, filed on Mar. 22, 2000.

(51) Int. Cl. G06F 15/16; G06F 7/00

(52) U.S. Cl. 709/203; 709/217; 707/5

(57) ABSTRACT

A method and system for requesting services from at least one content resource. The method includes the steps of finding relevant remote specifications, optionally retrieving at least one of the remote specifications, displaying a specification menu on a user device, selecting from among choices in the specification menu, executing the specification corresponding to the selected choice, and displaying results of the step of executing on the user device.

### CROSS REFERENCE TO RELATED APPLICATIONS

This application claims the priority of U.S. Provisional Patent Application No. 60/191,123, filed Mar. 22, 2000 (and entitled “An Information Retrieval System For Mobile Devices”), which is incorporated in its entirety herein by reference.

This application claims the priority of U.S. Provisional Patent Application No. 60/211,483, filed Jun. 14, 2000 (and entitled “An Automatic Hierarchy-Based Text Classification Method”), which is incorporated in its entirety herein by reference.

This application claims the priority of U.S. Provisional Patent Application No. 60/212,594, filed Jun. 19, 2000 (and entitled “Advanced Dynamic Information Search Retrieval Systems”), which is incorporated in its entirety herein by reference.

This application claims the priority of U.S. Provisional Patent Application No. 60/237,513, filed Oct. 4, 2000 (and entitled “Advanced Search, Data-Retrieval, Classification And Other Methods For Better Utilizing, Interfacing And Retrieving Web-Based Services, Wireless Services And Documents”), which is incorporated in its entirety herein by reference.

This application claims the benefit of U.S. patent application Ser. No. 09/524,569, filed Mar. 13, 2000, and entitled “Information Search And Retrieval System”, which is incorporated in its entirety herein by reference.

This application claims the benefit of U.S. patent application Ser. No. 09/568,988, filed May 11, 2000, and entitled “Context-Driven Information Retrieval”, which is incorporated in its entirety herein by reference.

### FIELD OF THE INVENTION

The present invention relates generally to requesting services from resources and includes the use of mobile devices as input and display devices.

### BACKGROUND OF THE INVENTION

The Internet is an example of a network of resources. It contains an overwhelming amount of information and services about a multitude of topics, and the information available continues to increase at a rapid rate. However, the nature of the Internet, is that of an unorganized mass of information. Navigation to a specific desired site or service requires knowing the uniform resource indicator (URI) for the site, having a bookmark to the site (which is actually a stored uniform resource locator (URL) for the site), or successive requests for World Wide Web (web) pages until the site is found.

Repeat requests are needed in most cases since, even when a user gets to a desired site, he must enter more information or choose between options a number of times, to get to the Web page containing the exact information or service he needs.

Several mobile devices provide the ability to access the Internet, for example, personal digital assistants (PDAs) that use modems (wireless or wire-line), smart cellular phones (WAP-enabled, SMS-driven etc.), and pagers. However, these devices are generally characterized by similar problems, including a small display screen, limited user-interface capabilities, a small amount of memory, a relatively weak CPU, and a narrow bandwidth. Thus, accessing the Internet or other resources with these devices is awkward due to navigation and/or display problems.

### SUMMARY OF THE INVENTION

There is provided, in accordance with an embodiment of the present invention, a method for requesting services from at least one content resource. The method includes the steps of finding relevant remote specifications, optionally retrieving at least one of the relevant remote specifications, displaying a specification menu on a user device, selecting from among choices in the specification menu, executing the specification corresponding to the selected choice, and displaying results of the step of executing on the user device.

Moreover, in accordance with an embodiment of the present invention, the method further includes the step of initially receiving input from a user device.

Furthermore, in accordance with an embodiment of the present invention, the step of finding further includes the steps of classifying the subject of a service request according to the received input and selecting specifications having the same classification as the service request.

In addition, in accordance with an embodiment of the present invention, the step of finding further includes the step of selecting specifications corresponding to a userID.

Moreover, in accordance with an embodiment of the present invention, the step of finding further includes the step of selecting specifications according to the stored preferences of a user.

Still further, in accordance with an embodiment of the present invention, the specification is a script for requesting services for at least one specific content resource. The specification has variables therein and the received input is the values for the variables used to request services.

Furthermore, in accordance with an embodiment of the present invention, the specification is a script for manipulating and analyzing the received input, performing logical operations using the received input, and building service requests based on the received input.

Moreover, in accordance with an embodiment of the present invention, the step of executing includes the step of generating at least one service request to the at least one content resource.

In addition, in accordance with an embodiment of the present invention, the at least one service request includes instructions to an external application.

Furthermore, in accordance with an embodiment of the present invention, the method includes the steps of manipulating the at least one service request in the external application into a new service request and sending the new service request to the at least one content resource.

Also, in accordance with an embodiment of the present invention, the method includes the following steps performed by the external application: generating multiple service requests, each to one content resource, manipulating the output of each content resource, and sending a collated result from the manipulated output to the user device.

In addition, in accordance with an embodiment of the present invention, the method further includes the step of receiving additional input.

Moreover, in accordance with an embodiment of the present invention, the method further includes the step of adapting results for the user device.

Furthermore, in accordance with an embodiment of the present invention, the user device is a mobile connected device.

Still further, in accordance with an embodiment of the present invention, the user device is a computer-like device.

In addition, in accordance with an embodiment of the present invention, the steps of receiving are from at least one of a group including: text typed by a user, an SMS (short message services) message, a pager message, a WAP (Wireless Application Protocol) computer, a selected text in electronic media, a speech recognized audio input, and a scanned section of printed media.

Still further, in accordance with an embodiment of the present invention, the step of executing is performed locally.

Moreover, in accordance with an embodiment of the present invention, the step of executing is performed remotely.

Furthermore, in accordance with an embodiment of the present invention, the at least one service request is a WAP request.

Additionally, in accordance with an embodiment of the present invention, the at least one service request is an HTTP (Hypertext Transfer Protocol) request.

There is further provided, in accordance with an embodiment of the present invention, a method for using mobile and computer-like devices for requesting services from content resources including the steps of displaying a specification menu on a user device, selecting from among choices in the specification menu, executing the specification corresponding to the selected choice, and displaying results of the step of executing on the user device.

Furthermore, in accordance with an embodiment of the present invention, the method further includes the steps of finding relevant remote specifications and optionally retrieving at least one of the relevant remote specifications.

There is further provided, in accordance with an embodiment of the present invention, a method for classifying and dynamic specification selection. The method includes the steps of: receiving input from a user device, classifying the subject of a service request according to the received input, and selecting specifications having the same classification as the service request.

There is also provided, in accordance with an embodiment of the present invention, a system for requesting services from content resources. The system includes a request engine, a mobile user device in communication with the request engine, and a specification selector in communication with the request engine.

Moreover, in accordance with an embodiment of the present invention, the specification selector further includes a subject classifier and a dynamic specification selector.

There is further provided, in accordance with an embodiment of the present invention, a system for requesting services from at least one content resource. The system includes: a request engine, a service request classifier in communication with the request engine, a specification selector in communication with the service request classifier and the request engine, and a user device in communication with the information search and retrieval engine.

### BRIEF DESCRIPTION OF THE DRAWINGS

The present invention will be understood and appreciated more fully from the following detailed description taken in conjunction with the appended drawings in which:

FIG. 1 is a block diagram illustration of a service request system, constructed and operative in accordance with an embodiment of the present invention;

FIG. 2 is a block diagram illustration of the service selector of FIG. 1; and

FIG. 3 is a flow chart illustration of a method by which the service request system of FIG. 1 operates.

### DETAILED DESCRIPTION OF THE PRESENT INVENTION

Applicants have designed a system and method for requesting services from content resources including requests submitted using mobile connected devices. Mobile connected devices include, for example, pocket PCs, personal digital assistants (PDAs), smart cellular telephones, and pagers. The system allows a user of a mobile device to select or receive a text, choose a specific service related to the text from a library of services, and receive results directly on his device.

Text and context may possibly be obtained from within the textual context of electronic media such as a document or message (e.g. a mail message, a browser page, a memo, an SMS message, a pager message) either by selection by the user or as derived by the system automatically. Applicants have, in a further embodiment of the present invention, incorporated the receipt of “text” from speech recognition applications and printed media scanning applications.

Applicants have developed this system and method for service requests using specifications that may reside on either a user device or a centralized server. Additionally, such specifications may be either text and/or context independent or sensitive. The specifications may be selected and modified dynamically using the text and/or context.

The service request system and method of the present invention includes various types of services. It includes, for example, search and retrieval of information from a specific resource, or search and retrieval of general information from any appropriate resource, or it causes the performance of an action in the “real world”, such as a ticket purchase or sending email through a World Wide Web (web) based email service. Services may be located locally, on an Intranet such as a corporate network, or on any external network such as the Internet.

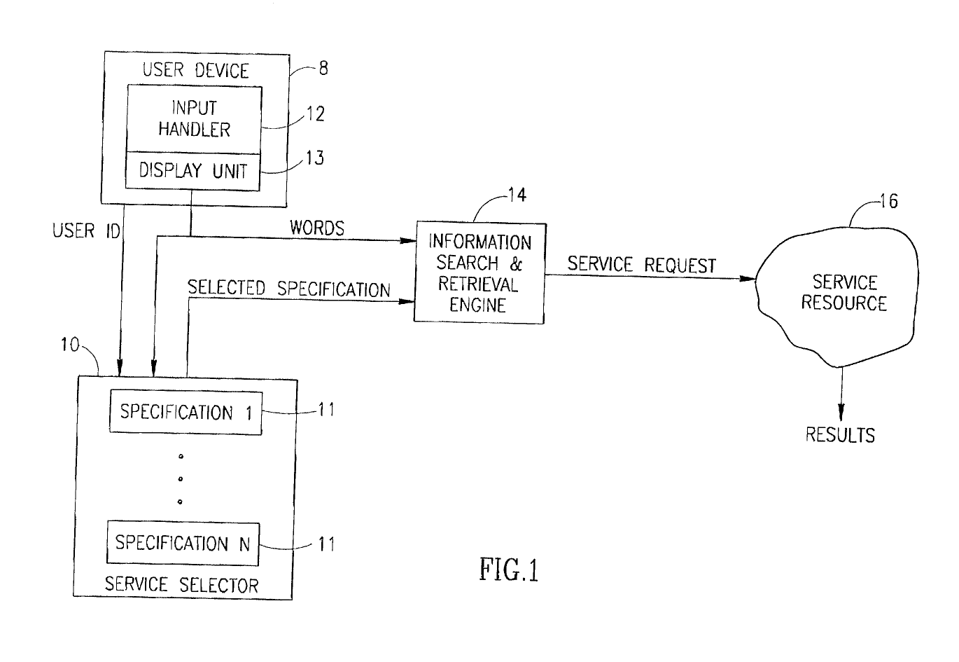

Reference is now made to FIG. 1, which is a block diagram illustration of a service request system, constructed and operative in accordance with an embodiment of the present invention. The system comprises a service selector 10 and an information search and retrieval engine 14 hereinbelow referred to as the “engine”, operative with a user device 8. Service selector contains a plurality of specifications 11. User device 8 comprises an input handler 12 and a display unit 13, which may be combined into one unit.

User device 8 may be a computer, a computer-like device, or any mobile connected device. Mobile connected devices include, for example, pocket PCs, personal digital assistants (PDAs), smart cellular telephones, and pagers. Computer-like devices include, for example, web-TVs. Input handler 12 may receive input from the user or an application and may output words comprising text and/or context. Hereinbelow, “words” will be used to refer to the output of input handler 12. Furthermore, any text or context that is supplied may be supplemented automatically as described hereinbelow.

Depending on the features of user device 8 input handler 12 may receive different types of input. Input may include, for example, text typed in by a user, a selection of words from within a document, or text messages such as those received by a pager or on a telephone with short message services (SMS). In general, input handler 12 may receive input from any application integrated into user device 8.

If user device 8 contains a selectable display area, the user may select a part of a displayed text. For example, the user may select text in an email or in a word processing application on a computer. Furthermore, if user device 8 is a smart telephone with SMS that allows the user to select a part of a message, then the selected part of the message will be used as the text and the rest of the message may be considered context. In cases where the user device cannot select a part of a message, the entire message would be considered the text.

If user device 8 includes an electronic media application such as a memopad application on a PDA, for example, on a PALM IIIc (available from Palm Inc., Santa Clara, Calif., US), then the user may select a portion of a memo as the text. Additional words surrounding the selected text are automatically added as context. Such a system, which automatically captures words in an electronic document, was implemented in the PalmZapper (available from Zapper Technologies Inc., Delaware, US, <www.zapper.com/palm/>)

Specification 11 has variables in the code script that may correspond to the words. Furthermore, specification 11 is a script which may be used for manipulating and analyzing the received input, performing logical operations using the received input, and building service requests based on the received input. Engine 14 then sends a service request to content resource 16 incorporating the results of the manipulations. For example, to order a book on the Internet, the user may enter either the BIN of the book or its title. The script in specification 11 instructs engine 14 how to analyze the data type of the words. If they are numeric, then a service request using a BIN is used, whereas if they are a non-numeric type, such as a character string, a service request using a book title is used.

This automatic addition of context to text and their use in the formation of information and service requests is described in detail in U.S. patent application Ser. No. 09/524,569, filed Mar. 13, 2000, and entitled “Information Search And Retrieval System”, which is incorporated in its entirety herein by reference. This explanation is applicable here.

In a further embodiment of the present invention, user device 8 receives audio input. Input handler 12 may comprise speech recognition software to convert the audio input into text and/or context textual input. Any recognition software known in the art may be used. Input handler 12 uses the text version of the audio input as it would any other input.

In a further embodiment of the present invention, input handler 12 receives input from a scanning device, for example a Quicktionary (available from WizCom Technologies Ltd., Jerusalem, Israel). Text is scanned by the scanning device and converted to electronic form. The output of the scanning device is used by input handler 12 as any other input.

User device 8 may also contain information regarding the user stored as user preferences. For example, user device 8 may be biased for a specific location. Service selector 10 will filter the services found so that only a subset of possible services, those appropriate for the location, will be returned. For example, a user receives an SMS message “Stay in one of the hotels.”. User device 8 is biased to receive information about London. Hence, only specifications 11 related to accommodations in London will be selected for use.

Service selector 10 passes a selected specification 11, describing a user-selected service request, to engine 14. Selected specification 11 contains details particular to a service provider, so that appropriate requests can be built for that service provider. Service providers may be part of an Intranet, an Internet, or exist locally. There may be more than one request generated by a single service request. In addition, input handler 12 passes words defining the service request to engine 14. Engine 14 then uses these two inputs to build a service request defined by the words of input handler 12 and appropriate to the selected service resource 16. Service resource 16 performs the service and provides the results back to the user. Any of the methods described in U.S. patent application Ser. No. 09/524,569, filed Mar. 13, 2000, may be used for the creation of the service requests.

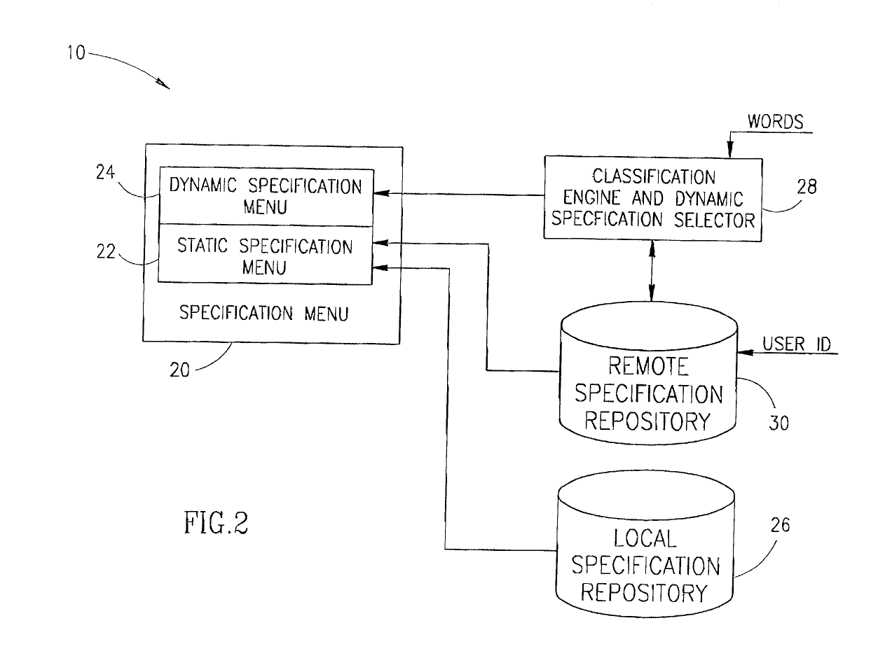

FIG. 2, to which reference is now made, is a block diagram illustration of service selector 10, constructed and operative in accordance with an embodiment of the present invention, comprising a specification menu 20, an optional local specification repository 26, an optional classification and dynamic specification selection engine 28, and an optional remote specification repository 30. Specification menu 20 is comprised of a static specification menu 22 and/or a dynamic specification menu 24.

Specification menu 20 presents the user with a menu of services from which to choose. The display of specification menu 20 on user device 8 comprises the list of choosable specifications 11. User device 8 may store only the name of specification 11, which is identified by a serviceID. The actual specification 11 may be stored in remote specification repository 30. Alternatively, the entire specification 11 may be stored in local specification repository 26.

User device 8 generally contains a list of predefined specifications 11 including both general purpose lists of services and user specific services. Static specification menu 22 comprises that group of specifications 11 that have been stored previously. A general-purpose list may include, for example, a news service, a dictionary, and a search engine. If the news service is selected, then news regarding the topic of the selected text is retrieved, whereas if the dictionary is selected, a definition of the text is retrieved.

The list of services may further be customized for the user. For example, a specialized dictionary reference or a particular service used often by the user may be included. In addition to specifications 11 contained in local specification repository 26, any specifications 11 in remote specification repository 30 marked as being applicable to the user's userID are added to static specification menu 22. The user may customize a given static specification menu 22. The user may switch between different static specification menus 22 according to his current needs.

As explained in detail in U.S. patent application Ser. No. 09/524,569, filed Mar. 13, 2000, specifications 11 contain additional details making use of the text and context to obtain complex service requests. An example of a complex service request is the retrieval of a news article about a particular subject, which has been translated to another language. In an exemplary scenario, the user receives a memo containing the words “import restrictions”. He selects these words and picks a specification 11 entitled “Spanish News”. The text is sent to a news archive of a news provider, such as BBC Online (from BBC, London, United Kingdom available at www.bbc.co.uk). The resulting page is received by engine 14 and forwarded to a web-based translation engine such as Babel Fish (from Alta Vista, Palo Alto, Calif., US available at http://babelfish.altavista.com/translate.dyn). The translated page is the desired result and is displayed.

Service requests are made by user device 8 to a network resource by the communications protocol appropriate to the device. For example, HTTP (Hypertext Transfer Protocol) or WAP (Wireless Application Protocol) may be used. User device 8 may connect via a server to an internal resource locally or on an Intranet such as a corporate database. Alternatively it may connect via a server to another information source via a network including the Internet and WAP-web, or, finally, it may connect directly to the Internet or equivalent World Wide Web network.

Classification and dynamic specification selection engine 28 may be used to classify the type of service being requested. Such a classification of the subject matter of the service request allows for the dynamic selection of specifications 11. Thus, the system of the present invention may add additional specifications 11 to those of specification menu 20, specifications 11 that are appropriate for the current service request. Remote specification repository 30 comprises many specifications 11 that have been classified by subject matter. When the classification and dynamic specification selection engine 28 classifies the words as pertaining to a subject, then any specifications 11 in remote specification repository 30 that have been marked as pertaining to the subject may be added. These additional specifications 11 make up dynamic specification menu 24.

Exemplary methods for use by classification and dynamic specification selection engine 28 are described in detail in 1) U.S. patent application Ser. No. 09/568,988, filed May 11, 2000 (and entitled “Context-Driven Information Retrieval”), 2) U.S. Provisional Patent Application No. 60/211,483, filed Jun. 14, 2000 (and entitled “An Automatic Hierarchy-Based Text Classification Method”), 3) U.S. Provisional Patent Application No. 60/212,594, filed Jun. 19, 2000 (and entitled “Advanced Dynamic Information Search Retrieval Systems”), 4) U.S. Provisional Patent Application No. 60/237,513, filed Oct. 4, 2000 (and entitled “Advanced Search, Data-Retrieval, Classification And Other Methods For Better Utilizing, Interfacing And Retrieving Web-Based Services, Wireless Services And Documents”), all of which are incorporated in their entirety herein by reference.

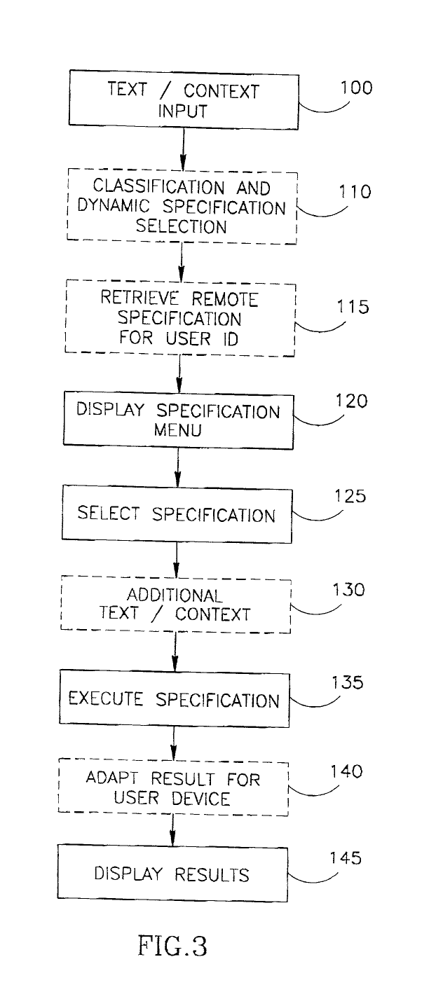

Reference is now made to FIG. 3, a data flow diagram, of the method for service requests from content resources, operative in accordance with an embodiment of the present invention. In step 100 text and/or context is received as described hereinabove.

These words may be sent to classification and dynamic specification selection engine 28. As described hereinabove, classification and dynamic specification selection engine 28 classifies the information requested using the words and selects appropriate specifications 11 from remote specification repository 30 (step 110). These specifications 11 appear in dynamic specification menu 24.

Specifications 11 for the userID of the user, which are stored remotely, are identified (step 115). References to these specifications 11 are added to static specification menu 22 in addition to those specifications 11 that are stored locally.

All specifications 11 that have been identified are filtered according to the user preferences of the user.

All specifications 11 that have been identified as either applicable to the user or appropriate for the given words are displayed to the user (step 120). This display, in an embodiment of the present invention, is a menu listing of titles of specifications.

The user selects a specification 11 (step 125). At this point, the user may also modify the words initially received (step 130). This may be desirable in order to refine the service request in light of the choices of specifications 11 that are displayed.

Specification 11 is executed (step 135) and the results of the service are obtained. Execution may take place locally or remotely. Repeated requests executed automatically may be necessary to obtain final results. The results may be obtained by access of a network resource.

A complex query requiring several requests may, for example, consist of a request to obtain financial information about a specific company. The user highlights the name of a company or a stock ticker in a financial article. Steps 100 to 130 are performed as hereinabove. Step 135 may include several requests to different finance sites. These sites may be queried either in parallel or sequentially and results are returned. A display of results is created from a combination of all the results returned.

Another complex query type may for example, include manipulation of the initial service request results into further service requests to the same or different content resources. When all service requests are completed, the intermediate service request results may be manipulated or combined and the final results displayed. An example is a program on that uses the text and context to perform several searches, and combines the results.

Results may be in any appropriate display language, such as XML (Extensible Markup Language), HTML (HyperText Markup Language), XHTML (Extensible HyperText Markup Language), CHTML (Compact HTML) or WML (Wireless Markup Language).

Results may optionally be sent to a device adapter before display (step 140). Depending on the user device, it may be advantageous to have the results translated to a format appropriate for display on the user device. For example, there are products known in the art that translate World Wide Web (web) pages for display on mobile devices. Google Inc. of Mountain View, Calif., US converts the HTML code to WML code for their web site that is available at <http://wap.google.com>. Alternatively, code may be written which analyzes the HTML code of a web site and handles the display of different types of elements as deemed appropriate. For example, icons may not be displayed and tables may be displayed in a modified format whereas text may be displayed as is. This approach is used, for example, by Zapper Technologies Inc in the Palm-Zapper. This is necessary due to the limited display space on mobile devices. Finally, the results are displayed to the user (step 145).

In a further embodiment of the present invention, the user information requests may be stored locally, for execution at a later time when the user connects to an appropriate service source.

It will be appreciated by persons skilled in the art that the present invention is not limited by what has been particularly shown and described herein above. Rather the scope of the invention is defined by the claims that follow:

What is claimed is:

1. A method for requesting services from at least one content resource comprising the steps of:
finding relevant remote specifications;
optionally retrieving at least one of said relevant remote specifications;
displaying a specification menu on a user device;
selecting from among choices in said specification menu;
executing the specification corresponding to said selected choice; and
displaying results of said step of executing on said user device.

2. A method according to claim 1 and further comprising the step of initially receiving input from a user device.

3. A method according to claim 2, wherein said step of finding further comprises the steps of:
classifying the subject of a service request according to said received input; and
selecting specifications having the same classification as said service request.

4. A method according to claim 1, wherein said step of finding further comprises the step of selecting specifications corresponding to a userID.

5. A method according to claim 1, wherein said step of finding further comprises the step of selecting specifications according to the stored preferences of a user.

6. A method according to claim 2, wherein said specification is a script for requesting services for at least one specific content resource wherein said specification has variables therein and said received input is the values for said variables used to request services.

7. A method according to claim 2, wherein said step of executing comprises the steps of:
manipulating and analyzing said received input;
performing logical operations using said received input; and
building service requests based on said received input.

8. A method according to claim 1, wherein said step of executing comprises the step of generating at least one service request to said at least one content resource.

9. A method according to claim 1, wherein said at least one service request includes instructions to an external application.

10. A method according to claim 9 and including the steps of manipulating said at least one service request in said external application into a new service request and sending said new service request to said at least one content resource.

11. A method according to claim 9 and including the following steps performed by said external application:
generating multiple service requests, each to one said content resource;
manipulating the output of each said content resource; and
sending a collated result from said manipulated output to said user device.

12. A method according to claim 1 and further comprising the step of receiving additional input.

13. A method according to claim 1 and further comprising the step of adapting results for said user device.

14. A method according to claim 1, wherein said user device is a mobile connected device.

15. A method according to claim 1, wherein said user device is a computer-like device.

16. A method according to claim 2, wherein said step of initially receiving is from at least one of a group including:
text typed by a user;
an SMS (short message services) message;
a pager message;
a WAP (Wireless Application Protocol) computer;
a selected text in electronic media;
a speech recognized audio input; and
a scanned section of printed media.

17. A method according to claim 12, wherein said step of receiving is from at least one of a group including:
text typed by a user;
an SMS (short message services) message;
a pager message;
a WAP (Wireless Application Protocol) computer;
a selected text in electronic media;
a speech recognized audio input; and
a scanned section of printed media.

18. A method according to claim 1, wherein said step of executing is performed locally.

19. A method according to claim 1, wherein said step of executing is performed remotely.

20. A method according to claim 8, wherein said at least one service request is a WAP request.

21. A method according to claim 8, wherein said at least one service request is an HTTP (Hypertext Transfer Protocol) request.

22. A method for using mobile and computer-like devices for requesting services from content resources comprising the steps of:
displaying a specification menu on a user device;
selecting from among choices in said specification menu;
executing the specification corresponding to said selected choice; and
displaying results of said step of executing on said user device.

23. A method according to claim 22 and further comprising the steps of:
finding relevant remote specifications; and
optionally retrieving at least one of said relevant remote specifications.

24. A method according to claim 23 and further comprising the step of initially receiving input from a user device.

25. A method according to claim 24, wherein said step of finding further comprises the steps of:
classifying the subject of a service request according to said received input; and
selecting specifications having the same classification as said service request.

26. A method according to claim 23, wherein said step of finding further comprises the step of selecting specifications corresponding to a userID.

27. A method according to claim 23, wherein said step of finding further comprises the step of selecting specifications according to the stored preferences of a user.

28. A method according to claim 24, wherein said specification is a script for requesting services for at least one specific content resource wherein said specification has variables therein and said received input is the values for said variables used to request services.

29. A method according to claim 24, wherein said step of executing comprises the steps of:
manipulating and analyzing said received input;
performing logical operations using said received input; and
building service requests based on said received input.

30. A method according to claim 22, wherein said step of executing comprises the step of generating at least one service request to said at least one content resource.

31. A method according to claim 22, wherein said at least one service request includes instructions to an external application.

32. A method according to claim 31 and including the steps of manipulating said at least one service request in said external application into a new service request and sending said new service request to said at least one content resource.

33. A method according to claim 31 and including the following steps performed by said external application:
generating multiple service requests, each to one said content resource;
manipulating the output of each said content resource; and
sending a collated result from said manipulated output to said user device.

34. A method according to claim 22 and further comprising the step of receiving additional input.

35. A method according to claim 22 and further comprising the step of adapting results for said user device.

36. A method according to claim 24, wherein said step of initially receiving is from at least one of a group including:
text typed by a user;
an SMS (short message services) message;
a pager message;
a WAP (Wireless Application Protocol) computer;
a selected text in electronic media;
a speech recognized audio input; and
a scanned section of printed media.

37. A method according to claim 34, wherein said step of receiving is from at least one of a group including:
text typed by a user;
an SMS (short message services) message;
a pager message;
a WAP (Wireless Application Protocol) computer;
a selected text in electronic media;
a speech recognized audio input; and
a scanned section of printed media.

38. A method according to claim 22, wherein said step of executing is performed locally.

39. A method according to claim 22, wherein said step of executing is performed remotely.

40. A method according to claim 30, wherein said at least one service request is a WAP request.

41. A method according to claim 30, wherein said at least one service request is an HTTP (Hypertext Transfer Protocol) request.

42. A method for classifying and dynamic specification selection comprising the steps of:
receiving input from a user device;
classifying the subject of a service request according to said received input; and
selecting specifications having the same classification as said service request.

43. A system for requesting services from content resources comprising:
a request engine;
a mobile user device in communication with said request engine; and
a specification selector in communication with said request engine.

44. A system according to claim 43, wherein said specification selector further comprises:
a subject classifier; and
a dynamic specification selector.

45. A system according to claim 43, wherein said specification selector further comprises:
a userID specification selector.

46. A system according to claim 43 and further comprising a display adapter.

47. A system according to claim 43 and further comprising a stored preferences filter.

48. A system according to claim 43, wherein at least one specification chosen by said specification selector is stored in a remote specification repository.

49. A system for requesting services from at least one content resource comprising:
a request engine;
a service request classifier in communication with said request engine;
a specification selector in communication with said service request classifier and said request engine; and
a user device in communication with said information search and retrieval engine.

50. A system according to claim 49, wherein said user device is a mobile device.

51. A system according to claim 49, wherein said user device is a computer-like device.

52. A system according to claim 49, wherein said specification selector further comprises:
a userID specification selector.

53. A system according to claim 49 and further comprising a display adapter.

54. A system according to claim 49 and further comprising a stored preferences filter.

55. A system according to claim 49 and wherein at least one specification chosen by said specification selector is stored in a remote specification repository.
